(19) United States
(12) Patent Application Publication
(10) Pub. No.: US 2008/0183914 A1
(43) Pub. Date: Jul. 31, 2008

(54) Method of and apparatus for addressing a target device within a chain of devices

(75) Inventors: Jeremy Richard Gorbold, Newbury (GB); John J. Reidy, Corbally (IE); John M. Wynne, Lisnalty (IE)

Correspondence Address: WOLF GREENFIELD & SACKS, P.C., 600 ATLANTIC AVENUE, BOSTON, MA, 02210-2206, US

(73) Assignee: Analog Devices, Inc, Norwood, MA (US)

(21) Appl. No.: 11/700,477

(22) Filed: Jan. 31, 2007

(51) Int. Cl. G06F 13/28

(52) U.S. Cl. 710/26

(57) ABSTRACT

A method of addressing a target device within a chain of devices, the method comprising a sending device setting an address value and sending data in association with the address value, and wherein each device receiving the address value and data compares the address value to a device number, and if they are different modifies the address value by a predetermined amount and transmits the data and the modified address value to a subsequent device.

### FIELD OF THE INVENTION

The present invention relates to a method of and apparatus for addressing a device within a daisy chain of devices, and for retrieving data from a device within a daisy chain of devices.

### BACKGROUND OF THE INVENTION

It is known that devices can be arranged in a “daisy chain” in order to transfer data from one device to another, and then on to subsequent devices. This arrangement is used to allow a serial interface, for example a three wire serial interface, to address many devices. However, within a daisy chain of such devices it is desirable to give each device a unique address such that a control system can send a message intended for one, and only one, of the devices and to receive a response from the device. It is again advantageous that the response includes the address of the sending device such that the identity of the sending device can be validated by the receiving device or system.

### SUMMARY OF THE INVENTION

According to a first aspect of the present invention there is provided a method of addressing a target device within a chain of devices, the method comprising a sending device setting an address value and sending data in association with the address value, and wherein each device receiving the address value and data compares the address value to a device number, and if they are different modifies the address value by a predetermined amount and transmits the data and the modified address value to a subsequent device.

It is thus possible to provide a system in which each and every device internally regards itself as having the same address. The nominal value of the address associated with each device is largely irrelevant, but for simplicity we might assume that each device regards itself as having address “0”. This means that there is no need to provide pins on the device package to enable the device address to be set by external switches or hardwired connections. This saves valuable pins on the packaging of a device and may enable the device to be encapsulated in a package with fewer pins, thereby giving rise to a cost saving. Even if the device cannot be packaged in a smaller packaging, the option to avoid having to provide external switches to set the address of the device reduces the cost of systems containing such a device, and where the systems are modular enables each module to be identical. The pins that would have been used to set the device address can then become available for other functions. The addresses can also be set using fuses or ROM, but then the addresses have to be programmed and tested, which is often inconvenient.

Advantageously, data transmitted in a first direction along the daisy chain of devices has its address value decremented with each device that the data passes through. This means, that if a sending device wants to transmit data to a device three devices along the daisy chain, then it sets the address value of the recipients device to N−1, where N=the relevant distance between the sending device and the target device. In this example N=3 so the address is set to “2”. The first device receiving the information will examine the address, see that the address is 2, understands that as its own address is 0 is that data is not destined for it, and then retransmit the data to the next device in the daisy chain after decrementing the address field. The next device receives data having an address value of “1”. It again compares this address with its own address “0” and noting that the data is not intended for it transmits the data on to the next device after decrementing the address field. The third device to receive the data examines the data, notes the address is “0”, which corresponds to its own address and thereby acts on the data.

Preferably when data is passing in a second direction along the daisy chain the address field is incremented. Thus, suppose the third device in the daisy chain wishes to send information to a system controller located at the end of the daisy chain, then it packages the data and associates it with its own address of “0”. The next device receiving the data travelling in that direction (towards the system controller) can infer that the data is not intended for it because of the direction of data travel. It therefore passes the data along the daisy chain after having incremented the address field. The next device, does the same, and so on until the data arrives at the system controller located at the end of the daisy chain. It can then use the address field to determine from which device within the daisy chain the data originated.

It is thus possible to provide a inexpensive way of addressing a specific device within a daisy chain of devices, and identifying the source device when data is transmitted from the daisy chain.

According to a second aspect of the present invention there is provided a method of transferring data from a Jth device to a Kth device in a chain of devices, wherein the Jth device forms an address value as a function of the difference between J and K, and sends data in association with the address value, and wherein each device receiving the data examines the address value to determine whether it is in intended recipient of the data, and if it determines that it is not the intended recipient it modifies the address value and passes the data along the chain of devices in association with the modified address value.

According to a third aspect of the present invention there is provided an addressable device adapted to be connected in series with other addressable devices, wherein the device is arranged to receive data which comprises an address value, and wherein the addressable device is arranged to compare the address value with a device number, and if they are different to modify the address value to form a modified address value and to transmit the data and modified address value to a subsequent device.

According to a third aspect of the present invention there is provided a data processing system comprising a plurality of addressable devices arranged in a series connected chain, wherein when a first device wishes to exchange data with a further device which is not immediately connected to the first device, the first device calculates an address value indicative of the number of devices intermediate the first device and the further device, and sends the data in association with the address value, and wherein each device examines the address value to determine whether the data is intended for it or should be passed along the chain.

### DESCRIPTION OF THE DRAWINGS

The present invention will be described, by way of non-limiting example only, with reference to the accompanying Figures, in which:

FIG. 1 schematically illustrates a plurality of battery monitoring devices connected in a daisy chain;

FIG. 2 is a schematic diagram of a battery monitoring device within the daisy chain of devices shown in FIG. 1, and constituting an embodiment of the present invention;

FIG. 3 schematically shows an example of a data word sending data as produced by one of the battery monitoring devices within the daisy chain of devices; and

FIG. 4 is a flow chart showing the modification of the address data as it passes through one of the devices shown in FIG. 1.

### BRIEF DESCRIPTION OF PREFERRED EMBODIMENTS OF THE PRESENT INVENTION

It is useful to consider an arrangement where a plurality of devices are provided in a monitoring arrangement and are connected in a “daisy chain”. Such a situation may occur in, for example, monitoring of batteries within an electric or hybrid vehicle.

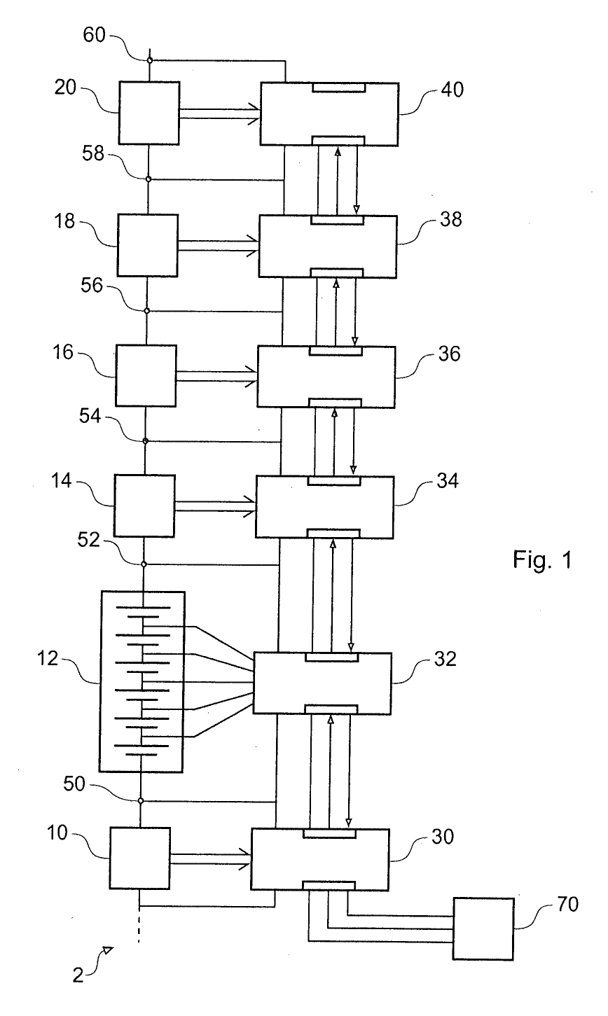

FIG. 1 schematically shows a battery stack, generally designated 2, comprising first, second, third, fourth, fifth and sixth groups of cells 10, 12, 14, 16, 18 and 20 respectively. Each of the groups of cells is nominally identical, and for clarity, only the individual cells within the second group 12 are individually drawn. In this example each group of cells comprises six individual cells. Each group of cells is associated with a respective battery monitoring device, 30, 32, 34, 36, 38 and 40. Suppose, for example, that each group of cells develops around 25 volts across it when fully charged and that the cathode of the first group 10 is connected to a local ground. We can then see that the voltage occurring at a first node 50 between the first group of cells 10 and the second group of cells 12 is approximately 25 volts compared to the ground. Similarly the voltage occurring at a second node 52 between the second group of cells 12 and the third group of cells 14 is approximately 50 volts. The voltage occurring at a third node 54 is 75 volts, the voltage occurring at a fourth node 56 is 100 volts, the voltage occurring at node 58 is 125 volts and the voltage occurring at node 60 is 150 volts.

Each battery monitor can derive power for its own operation from the battery module which it is monitoring. Thus, for example, battery monitor 34 receives its local negative voltage by connection to node 52 and its local positive voltage by connection to node 54. This defines a voltage difference of up to 25 volts across the monitor 34. Typically it is desired to monitor the voltage across each individual cell in the battery stack rather than the total voltage across each one of the groups. Consequently, as shown in detail for the second battery monitor 32 a plurality of connections are made to nodes intermediate each one of the cells associated with the monitor 32 such that the potential difference across each individual cell can be measured, for example, by an analog to digital converter provided within the battery monitor 32. The result for each cell may be sent as a digital word to a system controller 70 such that the system controller 70 has knowledge of the voltage occurring across each individual cell and can control switches (not shown) to selectively remove one or more cells from the current path through the battery stack during a charging phase. The potential within each battery monitor, as measured with respect to ground, varies considerably and if each individual monitor was connected directly to the system controller then considerable effort and expense would be required to ensure that the controller was protected from the DC voltage occurring at each battery monitor. It is safer and less expensive to connect the devices in a chain and to pass data along the chain.

In this example, only one of the battery monitors, namely the first one 30, is in communication with the system controller 70. It should be noted that the communication path between the first battery monitor 30 and a controller 70 may itself include an additional isolating component, such as an opto isolator, so as to ensure that the system controller is protected from voltages occurring within the battery stack and within the battery voltage monitors.

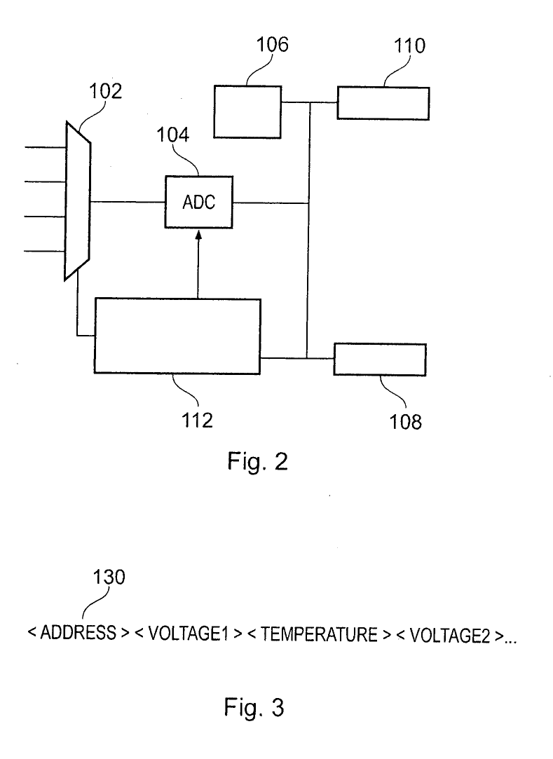

As shown in FIG. 2, battery voltage monitor, 30, 32, 34, 36 and so on includes a multiplexer 102, and analog to digital converter 104, a memory or similar temporary storage 106, a first data interface 108, a second data interface 110 and a controller 112 which co-ordinates the operation of the various parts of the battery monitor. The operation of the multiplexer, analog to digital converter, controller and memory are within the knowledge of the person skilled in the art and need not be described in detail here.

As can be seen from FIG. 1, the battery monitors are arranged in a daisy chain. Thus each monitor has at least a first neighbouring device connected to it and most have a second neighbouring device connected to them. Thus for the third battery monitor 34, its first neighbouring device is the second battery monitor 32 and its second neighbouring device is the fourth battery monitor 36.

A circuit for interchanging data between adjacent ones of the battery monitors is the subject of a co-pending patent application having the title “battery monitoring apparatus and daisy chain interface suitable for use in a battery monitoring apparatus”.

However, for the purpose of this application it is sufficient to assume that the devices are capable of exchanging data with one another and the interface may be constructed in accordance with the co-pending application, or may indeed by any other interface design, optionally including DC blocking capacitors or opto isolators such that the relative potential occurring at the neighbouring devices is not an issue. This is therefore merely sufficient to assume that we have a daisy chain of devices, and indeed because the devices are not limited to being battery monitors, they could all be at the same potential.

As noted hereinbefore, the system controller may wish to communicate with an individual one of the monitors. Thus, suppose, that it wishes to instruct battery monitor 36 to measure the voltage across one of its associated cells, or alternatively it may wish to send an instruction to the monitor 36 to, for example, remove one of the cells associated with it from the current path during a charging phase of the battery stack. We can use knowledge of the system configuration to address the device 36. The system controller has knowledge that device 36 is the fourth device in the daisy chain. It therefore knows that there are three devices intermediate it (i.e. devices 30, 32, 34) and its target device, namely device 36. Thus, when it is seeking to address device 36, it can take the number of intermediate devices into account and set an address word with a value such that, when each intermediate device acts on the address word, the address is modified in such a way that by the time the data arrives at device 36 device 36 recognises that the data is intended for it.

In a first embodiment of the present invention the address word associated with data is decremented when the data travels in a direction away from the system controller 70, that is up the stack as shown in FIG. 1. Therefore if the system controller wishes to address device 36, then it can set the address to three times the decrement value applied by each intermediate device. The decrement value may, for example, be equal to unity. In which case the system controller sets the address associated with the instructions that it is transmitting to “3”. When the first device 30 receives the data from the device/system controller 70, it examines the address field and notes that the address is “3”, which is not equal to its own address of “0”. The device 30 therefore transmits the data via its second interface to the second device 32, after decrementing the address field by unity. Thus the second device 32 receives the data associated with address of “2”. It again compares the address with its own internal address of “0”, and noting that it is not the intended recipient sends the data via its second interface to the third device 34 after having decremented the address field, such that the address is now equal to “1”. The device 34 receives the data, and notes that the address is not “0” so it is not the intended device. It therefore decrements the address field and sends it via its second interface to the next device. The device 36 receives the data, notes that the address associated with it is “0”, which corresponds to its own address, and then acts on the data/instruction without passing it on.

Alternatively, if the address data is modified in accordance with a modulo arithmetic, then the address field can be incremented as data travels from the device 70 to the target device. Assume, for example, that the devices operate on the address in modulo 15 arithmetic, such that the address would be incremented 12, 13, 14, 15 but the next increment would return the address to 0. In this arrangement when the device 70 wished to address the device 36, it would send an instruction associated with an address of 13. The first device 30 would receive the instruction, examine the address, note that it is not equal to 0, and then increment it before passing it on the second device 32. The second device 32 would receive the instruction associated with an address of “14”, examine it, note that it is not the intended recipient, increment the address to “15” and transmit it to the next device 34. The device 34 would receive the data/instruction, examine the address, note that it is not equal to “0” and therefore transmit it along the daisy chain after incrementing the address from “15” to “0”. Thus the device 36 would receive the instruction, examine the address, note that the instruction was associated with the address that pertained to that device and therefore act on it.

A similar methodology can be used when transmitting data from a cell. Suppose that in response to a control word from the system controller 70, each one of the battery monitors measures the voltage across each cell that it is monitoring, and also the temperature of individual cells or the group of cells. This data can be packaged in the word, as shown in FIG. 3, which might include an address field 130 indicating the battery monitor which made the measurement, then the voltage field for the first cell, this might then be followed by a voltage field, voltage 2, for the second cell, optionally a temperature for the second cell, a voltage for the third cell and so on. The precise format of the digital word is not important to this invention. Once the binary word has been derived, it is then necessary to transmit it from one voltage monitor to the next such that the word can be propagated down the chain of voltage monitors to the system controller 70. It should be noted that provided each monitor includes a first in first out buffer of sufficient length to buffer data that a monitor receives whilst sending its own data then all monitors can be instructed to read data from the batteries and to send it simultaneously as the daisy chain connection naturally causes the data to become serialised.

In this arrangement the address associated with the data is incremented as it passes along the chain. Thus data originating from device 34 would be sent with an origin address of “0”. This would be passed through device 32 having been incremented to an origin address of device 1. As this data passes through the device 30, this address is further incremented such that the address now becomes equal to “2”. When the data is received by the system controller 70, it examines the address which is equal to “2”, which informs the controller that the data has been passed through two intermediate devices. This is sufficient to determine that the data originated from the third device in the chain i.e. device 34.

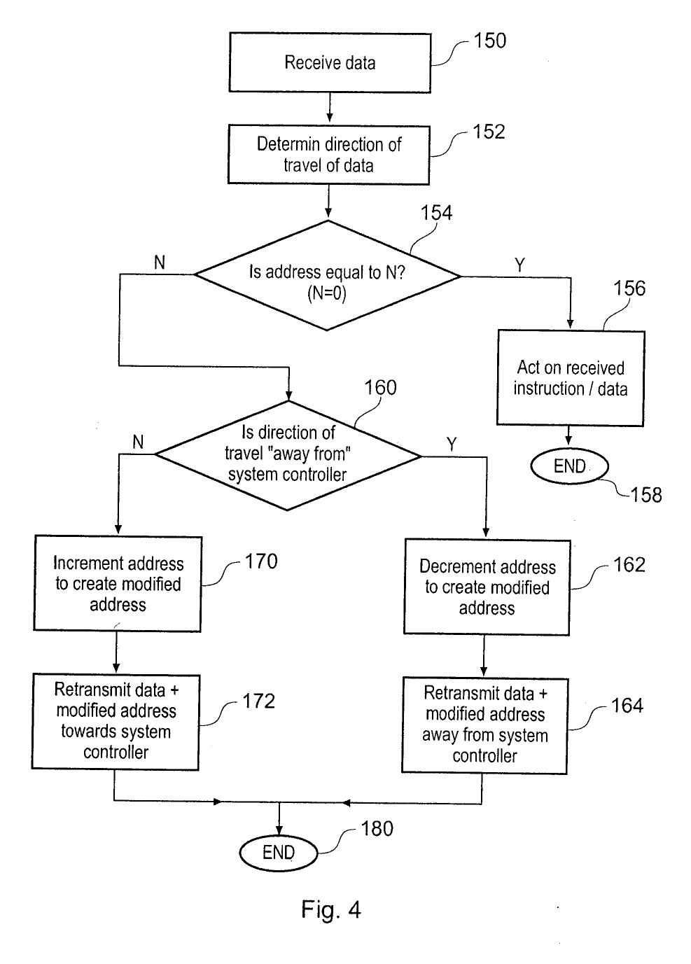

FIG. 4 is a flow chart illustrating the steps which may be undertaken by any one of the devices 30, 32, 34, 36 in order to modify the address associated with data or instructions received at that device, or intended for transmission through that device. The process starts at step 150 where the data is received at one of the first and second data interfaces 108 and 110 of the device. From there control passes to step 152 where the controller 112 identifies which of the interfaces has received the data and uses this information to determine the direction of travel of the data. Therefore, if the first address 108 receives the data then the controller knows that the data is travelling up the daisy chain shown in FIG. 1, whereas if interface 110 receives the data then the data is travelling down the daisy chain shown in FIG. 1. Control then passes to step 154 where the address associated with the data is examined. If the address is equal to “0” then the device knows that it is the intended recipient of the data and control is passed to step 156 where the controller acts in accordance with the data or instruction. Control then passes to step 158 which marks the end of this routine.

Returning to step 154, if the step is not equal to “0” then the device knows that it is not the intended recipient and control is passed to step 160. Here a test is made to determine whether the data is travelling away from the system controller. If data is travelling away from the system controller, i.e. up the daisy chain of FIG. 1, then control is passed to step 162 where a modified address is created by decrementing the address value and then the data and modified address is retransmitted at step 164 using the second data interface 110. From step 164 control passes to step 180 which represents an end of this routine. Returning to step 160, if the direction of data travel is not away from the system controller then control is passed to step 170 where a modified address is created by incrementing the address associated with the receive data and the data and modified address are transmitted using the first seal interface 108 at step 172. From step 172 control passes to step 180.

It is thus possible to provide an addressing scheme where the need to indicate to each device that it has a unique address is obviated because the transfer of data from one device to another along the chain causes the address of the transmitting and receiving devices to become explicit even though each device internally assumes that it has a unique address, but the internal address for each device is in fact the same.

1. A method of addressing a target device within a chain of devices, the method comprising a sending device setting an address value and sending data in association with the address value, and wherein each device receiving the address value and data compares the address value to a device number, and if they are different modifies the address value by a predetermined amount and transmits the data and the modified address value to a subsequent device.

2. A method as claimed in claim 1, in which the address value indicates the number of times that the data is to be passed through devices in the chain of devices, and each time the data is passed through a device the address is modified.

3. A method as claimed in claim 1 in which each device in the chain has the same device number.

4. A method as claimed in claim 3, in which when data travels along the chain in a first direction the address value is decremented by each device the data passes through.

5. A method as claimed in claim 4, in which when data travels along the chain in a second direction the address value is incremented by each device the data passes through.

6. A method as claimed in claim 3, in which each device number is zero.

7. A method as claimed in claim 1, in which a master device is located at a first end of the chain of devices, and it sets the address to the number of times that data has to be passed through intermediate devices to select a desired target device, where each intermediate device decrements the address value.

8. A method as claimed in claim 1, in which a master device is located at a first end of the chain of devices, and it sets the address value to a value of A minus the number of times that the data is to be passed through intermediate devices, where each intermediate device increments the address value and only a predetermined number of bits of address value are examined or the address value is modified by modulo arithmetic in base A.

9. A method as claimed in claim 1, in which a master device is located at a first end of the chain of devices and when a sending device sends data to the master device, it sends the data in association with a device address, and each intermediate device that relays the data modifies the device address by a predetermined value.

10. A method as claimed in claim 9, in which each intermediate device increments the device address.

11. A method of transferring data from a Jth device to a Kth device in a chain of devices, wherein the Jth device forms an address value as a function of the difference between J and K, and sends data in association with the address value, and wherein each device receiving the data examines the address value to determine whether it is in intended recipient of the data, and if it determines that it is not the intended recipient it modifies the address value and passes the data along the chain of devices in association with the modified address value.

12. A method as claimed in claim 11, in which the function used by the Jth device is (modified (J−K))+N and each intermediate device decrements the address value.

13. A method as claimed in claim 12, in which a device determines that data is intended for it when the address value equals N.

14. A method as claimed in claim 13, in which N=0.

15. A method as claimed in claim 11, in which the function set by the Jth device is A−(modulus (J−K)) and each intermediate device increments the address value.

16. An addressable device adapted to be connected in series with other addressable devices, wherein the device is arranged to receive data which comprises an address value, and wherein the addressable device is arranged to compare the address value with a device number, and if they are different to modify the address value to form a modified address value and to transmit the data and modified address value to a subsequent device.

17. An addressable device as claimed in claim 16, in which the device has at least first and second data interfaces such that the devices can be connected in series with a first interface of an (M+1)th device being connected to the second interface of an Mth device.

18. An addressable device as claimed in claim 16, in which each device has an internally pre-set device number.

19. An addressable device as claimed in claim 16, in which each device has the same device number.

20. A data processing system comprising a plurality of addressable devices arranged in a series connected chain, wherein when a first device wishes to exchange data with a further device which is not immediately connected to the first device, the first device calculates an address value indicative of the number of devices intermediate the first device and the further device, and sends the data in association with the address value, and wherein each device examines the address value to determine whether the data is intended for it or should be passed along the chain.

21. A data processor system as claimed in claim 20, in which when a device determines that it needs to pass data along the chain of devices, it modifies the address value and transmits the data and the modified address value to the next device in the chain.

22. A data processing system as claimed in claim 21, in which the address value is modified by a predetermined amount.

23. A data processing system as claimed in claim 22 in which the address value is decremented.

24. A data processing system as claimed in claim 22, in which the address value is decremented when data is passing in a first direction along the chain of devices.

25. A data processing system as claimed in claim 22, in which the address value is incremented.
